(19) United States
(12) Patent Application Publication
(10) Pub. No.: US 2016/0237887 A1
(43) Pub. Date: Aug. 18, 2016

(54) INTERNAL COMBUSTION ENGINE SYSTEM AND METHOD

(71) Applicant: Jeffrey Martin Lilly, Shepherd, MI (US)

(72) Inventor: Jeffrey Martin Lilly, Shepherd, MI (US)

(21) Appl. No.: 14/624,029

(22) Filed: Feb. 17, 2015

(51) Int. Cl. F02B 43/04; F02G 5/02; F01K 11/00; F02B 43/12; F02B 65/00

(52) U.S. Cl. CPC F02B 43/04; F02B 43/12; F02B 65/00; F01K 11/00; F02G 5/02

(57) ABSTRACT

An internal combustion engine system and method comprises an internal combustion engine adapted to be fueled by a diesel fuel and hydrogen gas, and to emit an exhaust of hot water and hot exhaust gas; a boiler for converting the exhausts from the internal combustion engine to steam; a steam engine adapted to receive the steam from the boiler; an electric generator powered by the steam engine and adapted to generate electric energy; a hydrogen generator powered by the electric generator and adapted to produce hydrogen gas; and conduit means for carrying the hydrogen gas to the internal combustion engine to fuel the engine for further operation; and means for reducing flow of diesel fuel to the internal combustion engine by about 30%, such that the engine runs on the hydrogen gas and the reduced diesel fuel, and the hot water and hot gas produced thereby flow to the boiler for continued operation of a cycle.

### BACKGROUND OF THE INVENTION

1. Field of the invention

The invention relates to internal combustion engine systems, such as are in common use in automotive and power generation systems, and more particularly, to a system and method adapted to improve efficiency in fuel use and in power generation.

2. Description of the Prior Art

In internal combustion engine systems, typically fueled by diesel fuel or gasoline, the exhausts from the internal combustion engines are released to the atmosphere and/or to a radiator in which a water supply is warmed, the water supply thereby cooling the radiator and the engine.

### SUMMARY OF THE INVENTION

The inventive concept herein described relates to an internal combustion engine system, which comprises an internal combustion engine adapted to be fueled by, for example, a diesel fuel and/or hydrogen gas, and to emit an exhaust of hot water and hot exhaust gas; a boiler for converting the exhausts from the internal combustion engine to steam; a steam engine adapted to receive the steam from the boiler; an electric generator powered by the steam engine and adapted to generate electric energy; a hydrogen generator powered by the electric generator and adapted to convert electrical power to hydrogen gas; and conduit means for carrying the hydrogen gas to the internal combustion engine to fuel the engine for further operation; and means for reducing the flow of diesel fuel to the internal combustion engine, such that the engine runs on a mixture of hydrogen gas and diesel fuel, and the hot water and hot gas produced thereby flow to the boiler for continued operation of a cycle.

### BRIEF DESCRIPTION OF THE DRAWING

Reference is made to the accompanying drawing in which is shown an illustrative embodiment of the invention, from which its novel features and advantages will be apparent.

FIG. 1 is a diagrammatic illustration of an internal combustion engine system illustrative of an embodiment of the invention.

The above and other features of the inventive concept, including various novel details of construction and combinations of parts, and method steps, will now be more particularly described with reference to the accompanying drawing and pointed out in the claims. It will be understood that the particular engine system and method embodying the invention are shown by way of illustration only and not as limitations of the invention. The concepts, principles and features of this invention may be employed in various and numerous embodiments without departing from the scope of the invention.

### DESCRIPTION OF A PREFERRED EMBODIMENT OF THE INVENTION

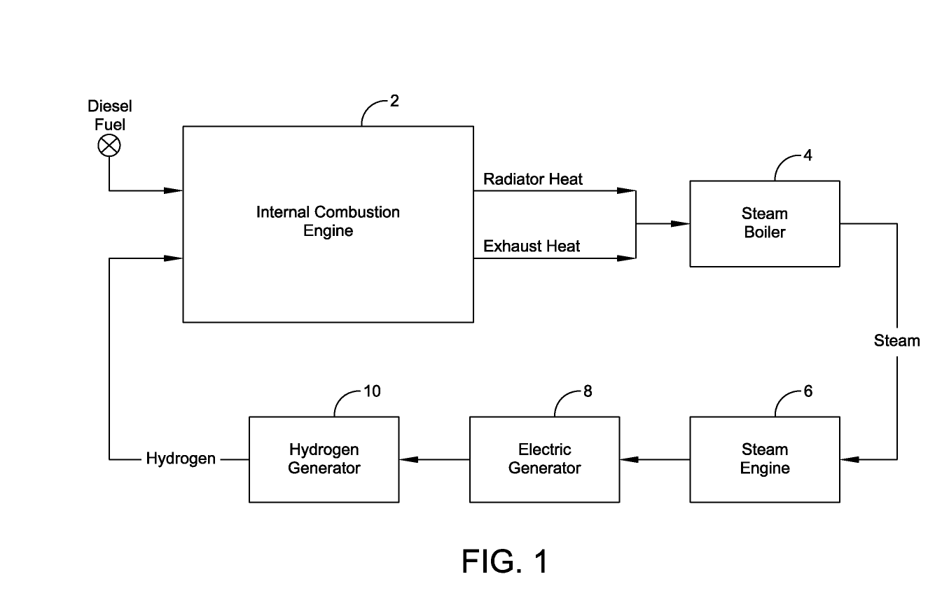

Referring to FIG. 1, it will be seen that the internal combustion engine system includes an internal combustion engine 2, which is adapted to operate on both diesel fuel and hydrogen gas. The engine 2 exhausts hot water and engine exhaust heat, both of which are directed to a boiler 4, which is adapted to produce steam, which is directed to a steam engine 6.

The steam engine 6 drives an electricity generator 8, from which electricity is directed to a hydrogen generator 10 in which electrical power is converted to hydrogen gas. The hydrogen gas is then conveyed to the engine 2, wherein the cycle starts anew, with the further input of the diesel fuel and the hydrogen gas.

Similarly, a method for fueling an internal combustion engine with a diesel fuel, and with hydrogen gas which is produced by the exhaust of the engine, comprises the steps of starting the engine with diesel fuel, combining hot water and hot exhaust gas from the engine in a steam boiler to provide a steam exhaust, directing the steam exhaust to a steam engine adapted to drive an electric generator, providing a hydrogen generator which is driven by electrical power from the electric generator, and which is adapted to convert electrical power to hydrogen gas, and directing the hydrogen gas to the internal combustion engine, the engine being adapted to operate on the hydrogen gas fuel and up to about 30% less diesel fuel. Thus, the supply of diesel fuel to the internal combustion engine is reduced by about 70%, such that the internal combustion engine is driven by hydrogen gas and 30% less diesel fuel than in the case of a diesel engine.

The internal combustion engine may be used to drive any selected device as is normally driven by an internal combustion engine.

It is understood that a present invention is by no means limited to the particular construction herein disclosed and/or shows in the drawings, but also comprises any modifications or equivalents within the scope of the claims.

What is claimed is:

1. An internal combustion engine system for fueling an internal combustion engine with diesel fuel and with hydrogen gas, the system comprising:
an internal combustion engine adapted to operate on diesel fuel or on hydrogen gas, and on a combustion thereof;
a hot water radiator adapted to cool said internal combustion engine and to dispense water therefrom;
a gas exhaust for dispensing exhaust gas from said internal combustion engine;
a steam boiler adapted to receive water and exhaust gases from said radiator and said exhaust gases from said internal combustion engine, and producing steam;
a steam engine adapted to receive steam from said boiler and having means for generating electricity;
an electric generator adapted to be driven by said steam engine;
a hydrogen generator powered by said electric generator and adapted to produce hydrogen gas; and
fuel input means adapted (1) to deliver hydrogen gas from said hydrogen generator, and (2) to deliver diesel fuel to said internal combustion engine;
wherein said internal combustion engine is adapted to be initially fueled by the diesel fuel and thereafter to be fueled by a combination of hydrogen gas and diesel fuel.

2. A method for fueling an internal combustion engine with diesel fuel, and with hydrogen gas which is produced from exhausts of the engine, the method comprising the steps of:
starting operation of the internal combustion engine with diesel fuel;
combining hot water and hot exhausts gas from the engine in a steam boiler to provide a steam exhaust;
directing the steam exhausts to a steam engine adapted to drive an electric generator;
providing a hydrogen generator which is driven by electrical power from the electric generator and which is adapted to convert electrical power to hydrogen gas; and
directing the hydrogen gas to the internal combustion engine;
wherein the internal combustion engine is adapted to operate on hydrogen gas fuel and diesel fuel; and
wherein the supply of diesel fuel to the internal combustion engine is reduced by about 30%, such that the internal combustion engine is driven by hydrogen gas and about 30% less diesel fuel, in combination.
